(19) United States
(12) Patent Application Publication
(10) Pub. No.: US 2006/0080044 A1
(43) Pub. Date: Apr. 13, 2006

(54) Measurement of the macromolecular proton density involved in magnetization transfer by means of magnetic resonance

(76) Inventor: Stefan Ropele, Lassnitzhohe (DE)

Correspondence Address: WILLIAM COLLARD;COLLARD & ROE, P.C., 1077 NORTHERN BOULEVARD, ROSLYN, NY, 11576, US

(21) Appl. No.: 10/521,512

(22) PCT Filed: Jul. 25, 2003
(86) PCT No.: PCT/EP03/08253

§ 371 Date: Jan. 18, 2005

(30) Foreign Application Priority Data
Jul. 26, 2002 (AT) 1145/2002

(51) Int. Cl. G06F 19/00

(52) U.S. Cl. 702/23

(57) ABSTRACT

A method and system for measuring the macromolecular proton concentration involved in magnetization transfer comprising the steps of
applying a first RF pulse of flip angle α₁ at a first time, applying a first magnetic field gradient along a predetermined direction,
applying a second RF pulse of flip angle α₂ at a second time τ₁ seconds after said first time,
applying a third RF pulse of flip angle α₃ at a third time τ₁+τ₂ seconds after said first time,
applying a fourth RF pulse of flip angle α₄ at a fourth time τ₁+τ₂+τ₃ seconds after said first time, applying a second magnetic field gradient along the same pre-determined direction as said first magnetic field gradient, and detecting a stimulated echo at a fifth time.

The present invention relates to a method of measuring the dilution of phase modulated spins as well as to a magnetic resonance imaging device which can be used for performing this method.

The present invention finds particular application in regard to medical diagnostic magnetic resonance imaging, but it is to be appreciated that the present invention also finds application in magnetic resonance spectroscopy and magnetic resonance imaging for other applications.

In biological tissues water protons are often compartmentalized in terms of their molecular mobility. Commonly, the two-pool model is used to explain macroscopic relaxation properties resulting from this compartmentalization: One pool, usually the largest in size, is associated to the “free” mobile bulk water, whereas a second pool is associated to motional restricted protons bound to macromolecules such as proteins or lipids. In “Magnetic Resonance in Medicine” (Vol. 10, P. 135-44 (1989)) S. D. Wolff and R. S. Balaban first coined the terms free and restricted proton pools to describe these different pools. Most importantly, both pools are coupled by an exchange of magnetization via chemical exchange and dipolar coupling. This phenomenon, commonly termed magnetization transfer (MT), is described in U.S. Pat. No. 5,050,609 and how to make use of it in magnetic resonance imaging is reviewed in “Magnetic Resonance Quarterly” (Vol. 8, P. 116-37 (1992)).

In medical diagnostic imaging the quantity of the restricted (macromolecular) proton pool is highly desirable as it is expected that this pool directly represents tissue structure and tissue integrity. However, depicting of the restricted proton pool is not possible because in most tissues the transverse magnetization of these protons decays with a time constant of approximately 10 μs or less. Unfortunately, conventional magnetic resonance imaging systems are not capable of sampling such ultrashort signals. Therefore, the restricted proton pool can be depicted only indirectly by exploiting the MT phenomenon.

Current methods for determining relaxation parameters of the two-pool model including the relative proton density employ both the formalism of the coupled Bloch Equations and spectral selective RF pulses with the intention to irradiate either the restricted or the free pool. Following spectral selective radio frequency (RF) irradiation, the signal response of the free pool is sampled and related to the model parameters.

In “Magnetic Resonance in Medicine” (Vol. 29, P. 759-766 (1993)) Henkelman R. M. et al. have derived an equation which relates the attenuation of the steady state magnetization to the resonance offset and power of a continuous wave saturation pulse and to some fundamental model parameters including the relative size of the restricted pool. The pool parameters can be obtained then by fitting this equation to several measurements obtained with different RF powers and frequency offsets. So far, this method could not be applied in a clinical setting because it exceeds the current limit by the specific absorption rate (SAR) and because measurement time is impractically long. Additionally, this technique suffers from the constraint of an additional measurement of the apparent relaxation time T1. Moreover, prior knowledge regarding the lineshape and the transverse relaxation time of the restricted pool is required.

Instead of off-resonant saturation pulses, another method, presented by Daniel Gochberg et al. in “Magnetic Resonance in Medicine” (Vol. 41, P. 1065-1072 (1999)), employs a train of short on-resonant inversion pulses. This approach benefits from a low SAR as the inversion pulses are separated by 120 ms. However, it suffers from a long measurement time as well. If more than one slice is required to be imaged, measurement time scales linearly with the number of slices as this method is not capable of true multislice imaging. So far, no in vivo results have been generated with this method.

More recent work, presented by John Sled et al. in “Magnetic Resonance in Medicine” (Vol. 46, P. 923-931 (2001)) and by Vasily Yarnykh in “Magnetic Resonance in Medicine” (Vol. 47, P. 929-939 (2002)) is also based on the steady state solution of the coupled Bloch Equations but regards pulsed RF saturation by incorporating numerical calculations. However, these newer methods are still not suited for routine use due to long acquisition times and extensive calculations.

It is an object of the present invention to provide a above described method which is capable of eliminating the drawbacks of the prior art and which enables a fast and low specific absorption rate (SAR) method for measuring the macromolecular proton density.

The present invention relates to magnetic resonance spectroscopy or imaging techniques in which an initial preparation of the proton magnetization is performed by two radio frequency pulses which causes all, or a portion of, the proton magnetization in the volume of interest to be oriented longitudinally. The application of a gradient field between these RF pulses causes the longitudinal magnetization to be modulated along the field direction. Such a preparation scheme, commonly known as stimulated echo preparation, does only affect protons of the free mobile tissue water. The restricted proton pool is not affected, because a RF pulse separation time is chosen that is much longer than the transverse relaxation time of the restricted proton pool. The present invention, therefore, employs above preparation scheme such as to label the free water protons and uses these protons as an intrinsic indicator to measure the size of the restricted pool. Following labelling, the concentration and therefore the signal intensity of the labelled protons will decrease as the labelled protons “dilute” into the restricted proton pool via magnetization transfer. Additionally, the labelled protons are also subject to longitudinal relaxation. Probing the labelled magnetization by means of a third RF pulse after different mixing times yields an indicator decay curve. From this curve the relaxation and dilution effects are separated by a bi-exponential analysis and the size of the restricted proton pool is calculated according to indicator dilution theory.

In accordance with a preferred embodiment of the invention, an additional RF pulse is applied between the labelling pulses and the final readout pulse. This additional pulse is intended to change the magnetization in the free proton pool only. Additionally, a mixing time, i.e. the time between the second and the last RF pulse, is used that is twice the time needed for both proton pools to restore equilibrium. Then, the size of the restricted pool is determined from two acquisitions, where the flip angle of said RF pulse is 0° in one run and 180° in the other run. Said RF pulse can also be a composite pulse that provides a constant specific absorption rate independent of the effective flip angle.

Alternatively, in a variation of the method, the flip angle of said RF pulse is held constant throughout several runs, where the time between said RF and the final readout pulse is varied. Such a variation allows to make the mixing time shorter than it takes to restore equilibrium. In this fashion, scan time can be reduced.

In an additional variation of the method, in accordance with the invention, said RF pulse is applied with a resonance offset such as to selectively saturate a part of the restricted pool magnetization. Thereby one obtains information about the spatial distribution of different spectral components of the restricted pool. In accordance with this variation, said off-resonant RF pulse can be replaced by a train of off-resonant RF pulses. In this manner, a higher degree of saturation and a higher spectral selectivity are achieved.

Further characteristic features of the invention and those already mentioned above will be explained in more detail by way of the accompanying drawings, wherein

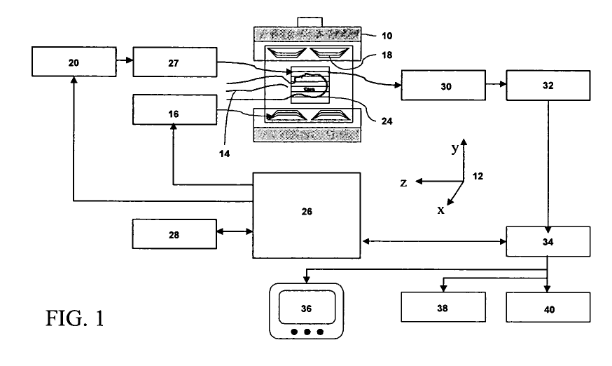

FIG. 1 shows a block diagram of a magnetic resonance imaging system that may be programmed to measure the macromolecular proton density;

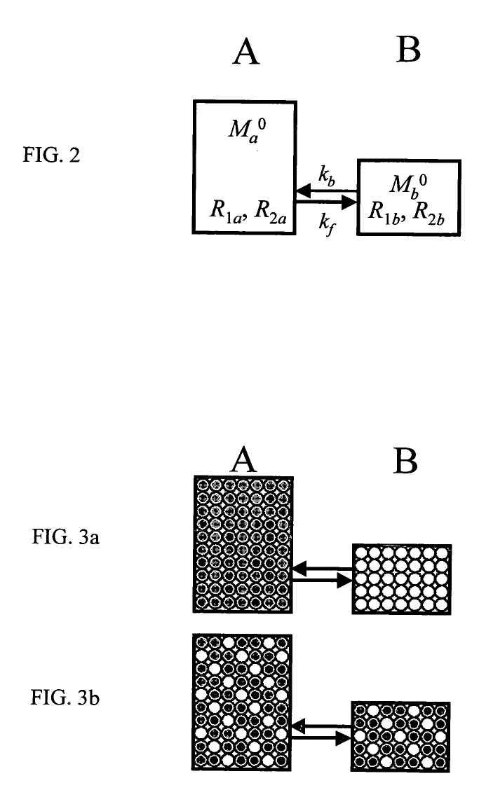

FIG. 2 is a simplified model of relaxation in heterogeneous tissues;

FIG. 3 illustrates the principal of the indicator dilution technique to measure the volume of distribution or the fractional volume;

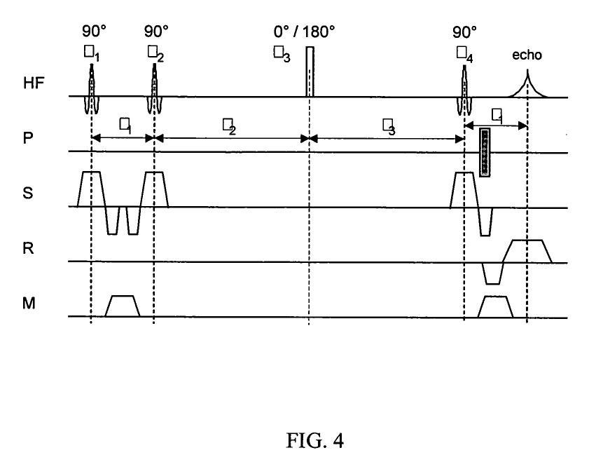

FIG. 4 shows a preferred MR pulse sequence for the determination of the macromolecular proton fraction;

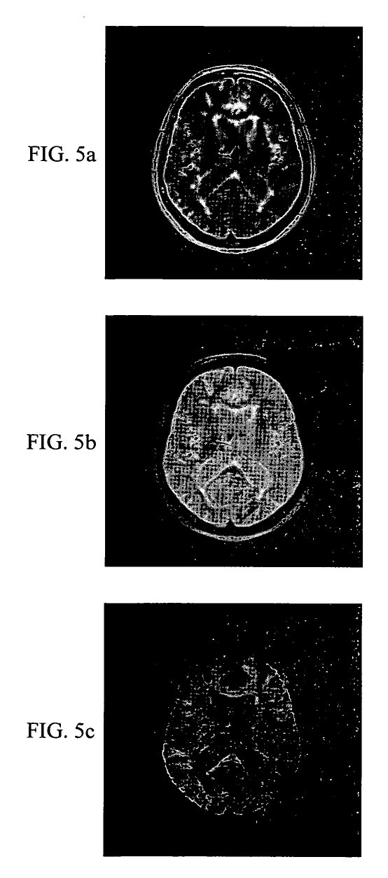

FIG. 5a-5c show the mapping of the macromolecular content in brain tissue with the preferred embodiment of the invention; and

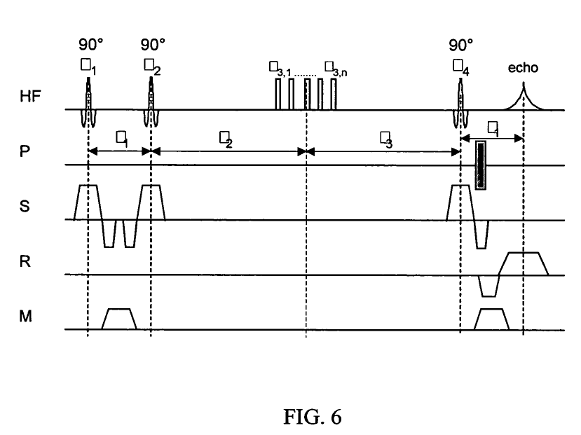

FIG. 6 illustrates a variation of the preferred pulse sequence.

Below, a technique for measuring the macromolecular ¹H density in relative or absolute terms in a two-step or multi-step scan will be described with references to FIGS. 1-6. The description given herein with respect to those figures is for explanatory purpose only and is not intended in any way to limit the scope of the invention.

A system for acquiring the data and generating the images is shown in FIG. 1. This system can be a 1.5 T or 3 T whole-body system from Philips Medical System, Best, The Netherlands, or any other suitably equipped MRI system that may be programmed to measure the macromolecular proton concentration. As illustrated, a magnet 10 generates a static, fundamental magnetic field along a z axis 12, in which an object or the body of a patient 14 to be examined is situated. The system additionally comprises gradient amplifiers 16, gradient coils 18, transmitter 20, RF power amplifier 22, RF coils 24 for generating pulse sequences for application to selected slices of the patient's 14 anatomy or the sample. The control of the pulse sequence is done by a sequence control unit 26, which can be programmed through a scan control interface 28. Since software techniques for generating pulse sequences with the characteristics defined below are believed to be well-known to those skilled in the art, such pulse generating techniques will not be described in further details herein. The signal generated by the pulse sequence is received by signal receiver 30 and digitized at digitizer 32 for application to an arithmetic unit 34 for processing in accordance with the technique of the invention. The processed signal is then displayed on a display unit 36. Data storage 38 and filming with a camera device 40 may be provided additionally. To synchronize the pulse sequence with physiological signals from patient 14, a cardiac synchronization unit 42 and a controlling device 44 for respiratory motion may also be provided.

Now, suppose water protons in tissue to be in two different states in regard to their molecular mobility. The compartmentalization in terms of molecular mobility is illustrated in FIG. 2. This figure shows a simplified model of relaxation in heterogeneous tissues. This is commonly know as the two-pool model. The pool A corresponds to ¹H spins in “free” mobile bulk water, whereas the second pool B, usually much smaller in size, corresponds to motional restricted ¹H spins bound to macromolecules. Pool B will be referred to as restricted or macromolecular pool. Each pool is characterized by its intrinsic relaxation rates R₁ and R₂ and by its size Mₐ⁰ and M_{b}⁰. Most importantly, there is an intermediate to fast exchange of magnetization between both pools as indicated by the first order forward and backwards transfer rates k_{f} and k_{b}. The fundamental parameter which can be measured with the present invention is the size of the macromolecular pool. For simplicity the molar fraction f will be used in further calculations, which is the relative size of the macromolecular pool and which can be written as

$$f = \frac{{M}_{b}^{O}}{{M}_{o}^{O}} . \qquad [ 1 ]$$

Since the condition for microscopic reversibility has to be fulfilled, Mₐ⁰·k_{f}=M_{b}⁰·k_{b} and Equation [1] can also be written as

$$f = \frac{{k}_{f}}{{k}_{b}} . \qquad [ 2 ]$$

As known by those skilled in the art of biomedical engineering, a common concept to determine the unknown distribution of volumes or fractional sizes is to measure the dilution of an indicator. The indicator can be of any type, but must be inert and directly accessible to a measurement such as in pool A in FIG. 3(a) for instance. After application of the indicator into pool A, indicated by the filled circles, an exchange process with pool B will start. As soon as the dilution of the indicator, caused by diffusion or other exchange processes, has reached a steady state, i.e. the concentration of the indicator is the same in both pools (FIG. 3(b)), the relative volume fraction or pool size can be calculated from the change in indicator concentration because

$$[ {c}_{ss} ] = [ {c}_{O} ] \frac{1}{f + 1} \qquad [ 3 ]$$

where [c₀] is the initial concentration in pool A and [cₛₛ] is the steady state concentration.

The present invention uses labelled spin magnetization as an inherent and exchangeable indicator. Spin labelling is achieved with a stimulated echo preparation scheme, consisting of two successive RF pulses, preferably with a flip angle of 90°, and a gradient field between. For those skilled in the art it is well known, that the gradient field causes a phase modulation of the transverse magnetization along the field direction. After applying the second RF pulse, the phase modulation turns into an modulation of the longitudinal magnetization. The present invention uses a RF pulse separation which is much longer than the transverse relaxation time of the restricted proton pool. This ensures, that only spins in the free proton pool are labeled even if the RF pulses partly saturate the restricted pool. Following the generation of this “indicator”, subsequent decay of the labelled spins with increasing mixing time is caused primarily by two processes. These are the dilution effect and T1 relaxation. This process can be modelled by regarding relaxation and magnetization exchange in the two pool system:

$$\begin{matrix}\frac{{dM}_{a} ( t )}{dt} = - {M}_{a} ( t ) ( {R}_{1 a} + {k}_{f} ) + {M}_{b} ( t ) {k}_{b} \\ and & [ 4 ] \\ \frac{{dM}_{b}}{dt} = - {M}_{b} ( t ) ( {R}_{1 b} + {k}_{b} ) + {M}_{a} ( t ) {k}_{f} & [ 5 ]\end{matrix}$$

where the subscript a and b refer to the free and restricted pool and M(t) is the magnetization of the labelled ¹H spins.

Solving Equations [4] and [5] with the condition of M_{b}(t=0)=0 gives a biexponential function for the decay of the labelled spins. Only the solution for the free pool is considered here because the bound pool will not contribute to the measured signal due to its extremely high R₂:
Mₐ(t)=M₀(C₁ exp(−λ₁t)+C₂ exp(−λ₂t)) [6]
with

$${λ}_{1 , 2} = 0.5 ( {k}_{b} + {k}_{f} + {R}_{1 a} + {R}_{1 b} ) \pm 0.5 \sqrt{\begin{matrix}{( {k}_{b} + {k}_{f} + {R}_{1 a} + {R}_{1 b} )}^{2} - \\ ( {R}_{1 a} {R}_{1 b} + {R}_{1 a} {k}_{b} + {R}_{1 b} {k}_{f} )\end{matrix}}$$

$$\begin{matrix}{C}_{1} = \frac{{λ}_{1} - {k}_{b} - {R}_{1 b}}{{λ}_{1} - {λ}_{2}} \\ and & [ 8 ] \\ {C}_{2} = \frac{{λ}_{1} - {k}_{f} - {R}_{1 a}}{{λ}_{1} - {λ}_{2}} & [ 9 ]\end{matrix}$$

where M₀ is the maximum magnetization available immediately after labelling. The rate λ₁ is a “fast” rate which is responsible for the quick approach to a steady state between both pools. In contrast, λ₂ is a “slow” rate and is roughly comparable to R₁ obtained from a conventional T₁ measurement. It is notable that λ₁ and λ₂ are identical to the rates given by the general solution of the coupled Bloch equations after disturbance of the equilibrium (Journal of Magnetic Resonance, Vol. 31, P. 207-229 (1978)). However, the constants C₁ and C₂ found here differ from this solution.

In most tissues the backward transfer rate k_{b} is much higher than the longitudinal relaxation rates. At 1.5 T k_{b} is approximately 16 times higher in white matter, 35 times higher in gray matter and 70 times higher in muscle than any of the longitudinal relaxation rates (Magnetic Resonance in Medicine, Vol. 33, P. 476-482 (1995), Magnetic Resonance in Medicine 35:277 (1996)). Therefore, the condition k_{b}>>R₁ₐ, R_{1b} allows to reduce the constants C₁ and C₂ to:

$$\begin{matrix}{C}_{1} = \frac{f}{f + 1} \\ and & [ 10 ] \\ {C}_{2} = \frac{1}{f + 1} & [ 11 ]\end{matrix}$$

Rewriting Eq. [6] for the measured signal intensity obtained from a stimulated echo will result in:

$$S ( t ) = {S}_{O} \frac{1}{f + 1} ( f exp ( - {λ}_{1} t ) + exp ( - {λ}_{2} t ) ) \qquad [ 12 ]$$

where S₀ is the maximal possible signal intensity that would be expected for a mixing time of zero. Thus, f can be calculated from a bi-exponential fit to a stimulated echo data set obtained with several different mixing times. It is important to note that f then is independent of the initial state of both pools. Ineffective labelling of the free pool will result in a lower dynamic range of the decay curve, but this will be reflected only in a decrease of S₀ and in the goodness of the fit. The result is also insensitive to any incidental irradiation of the restricted pool as long as this does not occur during the mixing period. For a mixing period much longer than 1/λ₁ (at 1.5 T this corresponds to 150-200 ms in brain white matter), Equation [12] can be rewritten as

$$S ( t ) = {S}_{O} \frac{1}{f + 1} exp ( - {λ}_{2} t ) . \qquad [ 13 ]$$

When compared to Equation [3] it is obvious that labelled spins can be treated as an indicator provided longitudinal relaxation is considered.

Now, consider a two-point pulse sequence such as in FIG. 4, which makes use of the dilution effect of phase modulated spins. FIG. 4 shows a preferred MR pulse sequence for the determination of the macromolecular proton fraction. This sequence exemplarily employs gradients for slice selection (S), phase encoding (P), frequency encoding (R), and labelling (M). The sequence is performed twice without and with a 180° RF pulse placed in the center of the mixing period. The first run serves as reference scan to asses the magnitude of the relaxation term exp(−λ₂TM) which is equal for both runs. The intention of the second run is to introduce an imbalance in the system. This is achieved with the 180° inversion pulse which changes the sign of the phase of the spins in the free pool only. This will be followed by a dilution of spins with opposite phase to the restricted pool and by a dilution of originally labelled spins from the restricted pool to the free pool. Immediately before the 180° RF pulse the signal from the labelled spins is

$${S}^{′} = {S}_{O} \frac{1}{f + 1} exp ( - {λ}_{2} {TM}_{1} ) . \qquad [ 14 ]$$

The signal intensity achieved in the first run is
S₁=S′ exp(−λ₂TM₂) [15]
and for the second run with the 180° RF pulse the signal intensity is

$${S}_{2} = - {S}^{′} \frac{1}{f + 1} exp ( - {λ}_{2} {TM}_{2} ) + {pS}^{′} \frac{f}{f + 1} exp ( - {λ}_{2} {TM}_{2} ) \qquad [ 16 ]$$

where the second term in Equation [16] gives the dilution from originally labelled spins in the restricted pool to the free pool. In above equations the inversion pulse is assumed to be perfect. However, the inversion pulse may also affect the spins in the restricted pool which is considered by the parameter p that gives the relative saturation of the restricted pool; total saturation will result in a p value of 0 while no saturation will be indicated by a value of 1. Usually, the restricted pool is expected to be smaller then the free pool (f<1). Then, if the signal intensity is obtained from a magnitude image the molar fraction is given by

$$f = \frac{( {S}_{1} - {S}_{2} )}{( {pS}_{1} + {S}_{2} )} . \qquad [ 17 ]$$

If R_{2b} is known or can be estimated, p can be obtained from numerical simulations of the effect of the inversion pulse on the bound pool. Equation [17] can be implemented to calculate pixel-by-pixel parameter images showing the molar fraction. To measure the absolute macromolecular proton concentration, the proton concentration of the free water pool has to be determined. This can be achieved, for instance, by estimating the size of the long T₂-component from an additional multi-echo experiment and by scaling it to a reference water sample of known temperature.

The pulse sequence of FIG. 4 was implemented on a Intera™ 1.5 T whole-body scanner.

The pulse sequence and method was validated with phantoms containing known concentrations of agar gel and bovine serum albumin. Additionally, the pulse sequence was used to evaluate the macromolecular content in brain tissue of several volunteers. FIG. 5 illustrates an application of the method of mapping the relative proton density of the macromolecular pool in a patient suffering from multiple sclerosis (MS). FIGS. 5(a) and 5(b) are the images corresponding to the two acquisitions performed with and without the inversion pulse α₃, respectively. FIG. 5(c) shows the macromolecular fraction computed pixel-by-pixel according to Equation [17]. In brain tissue the macromolecular pool is associated to the myelin lipids and proteins and is therefore expected to scale with myelin density. It can be nicely appreciated that white matter exhibits a higher macromolecular proton density than the gray matter does. MS plaques show a reduction in the macromolecular proton density. Of course, the macromolecular proton density in other tissues such as myocardial tissue or cartilage can be similarly determined using the techniques of the invention.

Although exemplary embodiments of the invention have been described in detail above, those skilled in the art will appreciate that many additional modifications are possible in the exemplary embodiment without materially departing from the novel teachings and advantages of the invention. The pulse sequence illustrated in FIG. 4 represents only some of many possibilities for measuring the macromolecular proton density from the dilution of phase modulated spins. In this sequence, a RF pulse (α₃) is applied to disturb the equilibrium of the labelled spins by manipulating the spins of the free proton pool. Alternatively disturbance of the equilibrium can be achieved with a sequences like in FIG. 4, but which uses single or trains with flip angles α_{3,1} . . . α_{3,n} of off-resonant RF pulses instead of the third RF pulse of flip angle α₃ in order to saturate the spins in the restricted proton pool. Such variation of the preferred pulse sequence is illustrated in FIG. 6. Also, this principle can like-wise be applied to sequences like in FIG. 4, but where the flip angle of the inversion pulse deviates from 180°, or to a scheme were τ₂ or τ₃ are varied over successive scans. Accordingly, all such modifications are intended to be included within the scope of this invention as defined in the following claims.

1. A magnetic resonance method of measuring the dilution of phase modulated spins in an object that contains protonated macromelecules, from which the macromolecular proton concentration involved in magnetization transfer can be calculated, wherein the steps of:
applying a first RF pulse of flip angle α₁ at a first time so as to generate a transverse magnetization in said object;
applying a first magnetic field gradient along a predetermined direction in said object so as to produce a phase modulation of ¹H spins along the direction of the gradient;
applying a second RF pulse of flip angle α₂ at a second time τ₁ seconds after said first time so as to flip the transverse magnetization into the longitudinal plane;
applying a third RF pulse of flip angle α₃ at a third time τ₁+τ₂ seconds after said first time;
applying a fourth RF pulse of flip angle α₄ at a fourth time τ₁+τ₂+τ₃ seconds after said first time so as to flip the longitudinal stored magnetization into the transverse plane;
applying a second magnetic field gradient along the same predetermined direction and with the same amplitude and duration as said first magnetic field gradient;
detecting a stimulated echo at a fifth time.

2. (canceled)

3. A method according to claim 1, wherein said third RF pulse is a composite RF pulse.

4. A method according to claim 1, wherein said third RF pulse is applied with a resonance offset so as to saturate partly or fully the magnetization associated to the macromolecular pool.

5. A method according to claim 1, wherein said third RF pulse has a flip angle α₃ of 0°, and said steps are performed more than two times, and said fourth time is altered over several subsequent scans.

6. A method according to claim 1, wherein said pulse sequence is a pulse sequence for multislice imaging.

7. A method according to claim 1, wherein said pulse sequence incorporates an additional encoding gradient for 3D imaging.

8. A method according to claim 1, wherein said fourth RF pulse is replaced by a train of RF pulses with a flip angle <90° in order to acquire more than one line in k-space per repetition.

9. A method according to claim 1, wherein said stimulated echo is sampled with a multi-shot or single-shot echo planar imaging technique.

10. A method according to claim 1, wherein the object is a patient, and wherein the first RF pulse is synchronized using electrocardiographic gating or peripheral pulse gating.

11. A method according to claim 1, wherein the object is a patient, comprising controlling the respiratory motion of the patient during application of the pulse sequence.

12. A method according to claim 1, comprising determining a longitudinal relaxation rate of said object in addition to the macremolecular proton concentration, whereas the longitudinal relaxation rate is calculated from the stimulated echo and from a spin echo that is sampled at a time 2τ₁ after said first time.

13. A method according to claim 1, wherein said object is the brain tissue of a patient and the macromolecular proton concentration represents myelin density of said patient.

14. A method according to claim 1, wherein said object is the myocardium of a patient and the macromolecular proton concentration reflects fiber density and structure and therefore tissue quality.

15. A method according to claim 1, wherein the macromolecular proton pool is a contrast agent administered to the object and the macromolecular proton density reflects the concentration of the contrast agent.

16. A magnetic resonance imaging device comprising a magnet (10) which generates a magnetic field about an object (14), gradient coils (18) which apply gradient pulses to said object (14), RF coils (24) which apply RF pulses to said object (14), driving circuitry (16, 22) which drives said gradient coils (18) and RF coils (24), receiving circuitry (30) which receives a signal from said object (14) in said magnetic field upon application of said gradient pulses and RF pulses, an arithmetic unit (34), a display device (36) for displaying said received and processed signals, wherein a sequence control device (26) which controls said RF coils (24) to generate and apply a first RF pulse of flip angle α₁ at a first time so as to generate a transverse magnetization in said object (14) and a second RF pulse of flip angle α₂ at a second time τ₁ seconds after said first time so as to flip the transverse magnetization into the longitudinal plane and a third RF pulse of flip angle α₃ at a third time τ₁+τ₂ seconds after said first time and a fourth RF pulse of flip angle α₄ at a fourth time τ₁+τ₂+τ₃ seconds after said first time so as to flip the longitudinal stored magnetization into the transverse plane, and which sequence control device (26) controls said gradient coils (18) to generate and apply a first magnetic field gradient after the application of said first RF pulse and to generate and apply a second magnetic field gradients after the application of the forth RF pulse along a predetermined direction in said object (14) and which generates an image of a stimulated echo detected by said receiving circuitry (30) at a fifth time.

17. (canceled)

18. An imaging device according to claim 16, wherein said sequence control device (26) is programmed to perform said third RF pulse with a resonance offset so as to saturate partly or fully the magnetization associated to the macromolecular pool.

19. An imaging device according to claim 16, wherein said sequence control device (26) is programmed for altering said third time over several subsequent scans.

20. An imaging device according to claim 16, wherein said sequence control device (26) controls the gradient amplifiers (16) such as to sample a signal with a digitizer (32) according to the multi-shot or single-shot echo planar imaging technique.

21. An imaging device according to claim 16, wherein a synchronization unit (42) connected with a device for measuring the electrocardiographic activity of a patient for synchronisation of the first RF pulse with the electrocardiographic activity of the patient.

22. An imaging device according to claim 16, wherein a controlling device (44) for controlling a respiratory motion of a patient during application of the pulse sequence.

23. An imaging device according to claim 16, wherein said sequence control device (26) is additionally programmed to sample a spin echo at a time 2τ₁ after said first time, in order to determine the longitudinal relaxation rate.
